(19) United States
(12) Patent Application Publication
(10) Pub. No.: US 2011/0131404 A1
(43) Pub. Date: Jun. 2, 2011

(54) APPARATUS AND METHOD FOR VISUALIZING GAME PACKET DATA

(76) Inventors: Dongchun LEE, Daejeon (KR); Kang Min SOHN, Daejeon (KR); Chang Joon PARK, Daejeon (KR)

(21) Appl. No.: 12/646,355

(22) Filed: Dec. 23, 2009

(30) Foreign Application Priority Data
Dec. 2, 2009 (KR) 10-2009-0118755

(51) Int. Cl. H04L 29/06; G06F 21/00

(52) U.S. Cl. 713/150; 726/13

(57) ABSTRACT

An apparatus for visualizing game packet data, includes a packet capturing unit for capturing game packet data transmitted and received during a game service; a decryption unit for decrypting the captured game packet data; and a packet filtering unit for extracting packet data having a valid protocol ID from the game packet data and extracting visualization data from the extracted packet data. Further, the apparatus for visualizing game packet data includes a virtual map creation unit for creating a virtual map using the extracted visualization data; and a visualization unit for displaying the visualization data in the created virtual map.

### CROSS-REFERENCE TO RELATED APPLICATIONS

The present invention claims priority of Korean Patent Application No. 10-2009-0118755, filed on Dec. 2, 2009, which is incorporated herein by reference.

### FIELD OF THE INVENTION

The present invention relates to a technique for visualizing game packet data; and, more particularly, to an apparatus and method for visualizing game packet data, which is capable of capturing transmitted packets, extracting visualization-related data from the packets and visualizing the extracted data.

### BACKGROUND OF THE INVENTION

As is well known, computer games have evolved from conventional games which could be independently executed on Personal Computers (PCs) into online games which enable users to access game servers over various types of communication networks, such as the Internet and mobile communication networks, and enjoy the games along with other users.

Such online games are advantageous in that users can always use the games regardless of time or space because the games are played in a virtual space and in that the creativity of game developers can be reflected in the games. For example, there are a variety of contents and types of online games, as follows: first-person shooting games which can each be played by a single user, board games such as Go-Stop or poker games, racing games, Role Playing Games (RPGs) in which a user plays a specific role, and Massively Multi-player Online Role Playing Games (MMORPGs) in which a plurality of game users participates and plays a game at the same time.

In general, when a user uses an online game service, the user must register as a member with the game service system which provides a corresponding game service. The member registration is chiefly performed via the website of a game service provider. When a user registers as a member, he or she sets an ID and a password, that is, authentication information, and uses the ID and the password as login information when he or she accesses a game server later on.

Furthermore, the user downloads and installs a game client application capable of executing the online game on his or her computer, and, when he or she wants to play the game, executes the installed game client application and logs in to the corresponding game server by inputting his or her ID and password, thereby starting to play the game.

Meanwhile, in an online game, a game client terminal extracts visualization information based on game packets entering from the game server and realizes visualization on a screen. Such visualization pertains to the game rendering field because visualization is performed on game screens based on game packets generated between a game server and a game client application, and the searching of game errors based on visualized information and the correction of a game server and a client application based on the found game errors pertains to the game quality guarantee field.

However, up to the present time, a game client terminal has had various limitations in the manipulation of a camera when performing a visualization function. The visualization supported by a game client prevents a camera from entering under the ground, limits the locations of a camera and a main character to within a predetermined distance, and causes the inconvenience of checking an object hidden by a building after turning around the building.

Due to these problems, a typical game developer removes the above-described camera limitations from a separate client version at the developmental stage, and imposes the removed camera limitation on a marketed client program again at the development completion stage, so that there is a problem with the visualization of data.

### SUMMARY OF THE INVENTION

In view of the above, the present invention provides an apparatus and method for visualizing game packet data which is capable of visualizing the location and attribute information of objects used to detect data errors using packet information.

In accordance with a first aspect of the present invention, there is provided an apparatus for visualizing game packet data, including: a packet capturing unit for capturing game packet data transmitted and received during a game service; a decryption unit for decrypting the captured game packet data; a packet filtering unit for extracting packet data having a valid protocol ID from the game packet data and extracting visualization data from the extracted packet data; a virtual map creation unit for creating a virtual map using the extracted visualization data; and a visualization unit for displaying the visualization data in the created virtual map.

In accordance with a second aspect of the present invention, there is provided a method for visualizing game packet data, including: capturing game packet data transmitted and received during a game service; decrypting the captured game packet data; extracting packet data having a valid protocol ID from the game packet data; extracting visualization data from the extracted packet data; creating a virtual map using the extracted visualization data; and displaying the visualization data in the created virtual map.

In accordance with an embodiment of the present invention, the present invention is configured to extract visualization information on the basis of game packet data exchanged between the game service server and the game client terminal and visualize the visualization information on a screen, and is applied to a general-purpose server/client game service using a packet protocol definition file and a decryption algorithm, so that it is possible to easily perform debugging for packet data errors and to reduce the game development period and cost.

Further, the present invention is configured such that a game packet data visualization apparatus captures game packet data between a game service server and a game client terminal, decrypts game packet data, extracts game packet data having a valid protocol ID, creates visualization data by extracting the location and attribute information of the game packet data, creates a virtual map using the extracted location information of the visualization data, and displays the visualization data in a virtual map in the form of a 3D or 2D screen, thereby solving the problems of the conventional art using the above-described technical means.

### BRIEF DESCRIPTION OF THE DRAWINGS

The objects and features of the present invention will become apparent from the following description of embodiments given in conjunction with the accompanying drawings, in which:

FIG. 1 is a block diagram showing the construction of a system for visualizing game data which is capable of capturing packets, extracting visualization-related data and visualizing the data in accordance with an embodiment of the present invention;

FIG. 2 is a block diagram showing the construction of a game packet data visualization apparatus which is capable of capturing packets, extracting visualization-related data and visualizing the data in accordance with the embodiment of the present invention;

FIG. 3 is a diagram showing the detailed construction of a packet filtering unit capable of filtering game packet data in accordance with the embodiment of the present invention;

FIG. 4 is a flow chart showing a process of capturing game packets, extracting visualization-related data and visualizing the data in accordance with another embodiment of the present invention; and

FIGS. 5A to 5E are diagrams showing the extraction and visualization of visualization-related data in accordance with the embodiment of the present invention.

### DETAILED DESCRIPTION OF THE EMBODIMENTS

Hereinafter, embodiments of the present invention will be described in detail with reference to the accompanying drawings which form a part hereof.

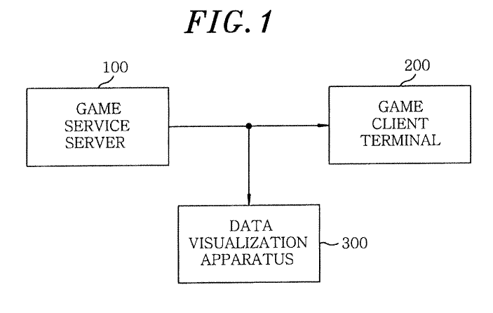

FIG. 1 is a block diagram showing the construction of a system for visualizing game data which is capable of capturing packets, extracting visualization-related data and visualizing the data in accordance with an embodiment of the present invention. The system for visualizing game data includes a game service server 100, a game client terminal 200, and a game packet data visualization apparatus 300.

Referring to FIG. 1, the game service server 100 refers to a server which provides a game service. The game service server 100 extracts a game client application requested by the game client terminal 200, and transmits the game client application to the game client terminal 200. When member registration has been completed using the game client application, the game service server 100 provides a game service to the game client terminal 200 by transmitting game packet data to the game client terminal 200.

The game client terminal 200 installs the game client application transmitted from the game service server 100, inputs and transmits member registration information using the game client application, and uses a game service on the basis of game packet data transmitted from the game service server 100.

Further, the game packet data visualization apparatus 300 captures game packet data exchanged between the game service server 100 and the game client terminal 200, decrypts the captured game packet data, extracts game packet data having a valid protocol ID from the decrypted game packet data, extracts only packet data, i.e., visualization data including location and attribute information necessary for visualization data from the game packet data having a valid protocol ID, creates a virtual map using the location information of the extracted visualization data, and displays the visualization data in the created virtual map in the form of a 3D or 2D screen.

Accordingly, by capturing game packet data between the game service server and the game client terminal, extracting visualization data by performing decryption and filtering, and creating a virtual map using the location information of the extracted visualization data, and displaying the visualization data in the created virtual map in the form of a 3D or 2D screen, the visualization data can be extracted from the game packet data and can be displayed effectively.

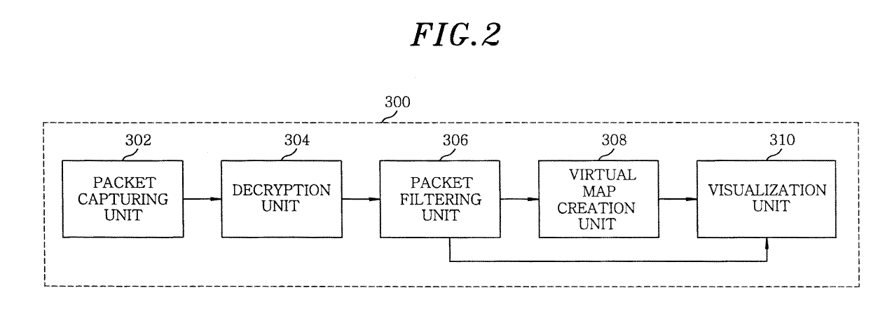

FIG. 2 is a block diagram showing the construction of a game packet data visualization apparatus which is capable of capturing packets, extracting visualization-related data and visualizing the data in accordance with an embodiment of the present invention. The game packet data visualization apparatus 300 includes a packet capturing unit 302, a decryption unit 304, a packet filtering unit 306, a virtual map creation unit 308 and a visualization unit 310.

Referring to FIG. 2, the packet capturing unit 302 captures game packet data (hereinafter referred to as “first game packet data”) exchanged between the game service server 100 and the game client terminal 200, and creates second game packet data by adding time information corresponding to the first game packet data.

Thereafter, the decryption unit 304 decrypts the captured game packet data. That is, the decryption unit 304 creates third game packet data by decrypting the second game packet data created by the packet capturing unit 302. Such decryption may be performed using a decryption algorithm which is provided in script form, such as Lua script form, or in plug-in form. If captured game packet data has not been encrypted, decryption does not need to be performed.

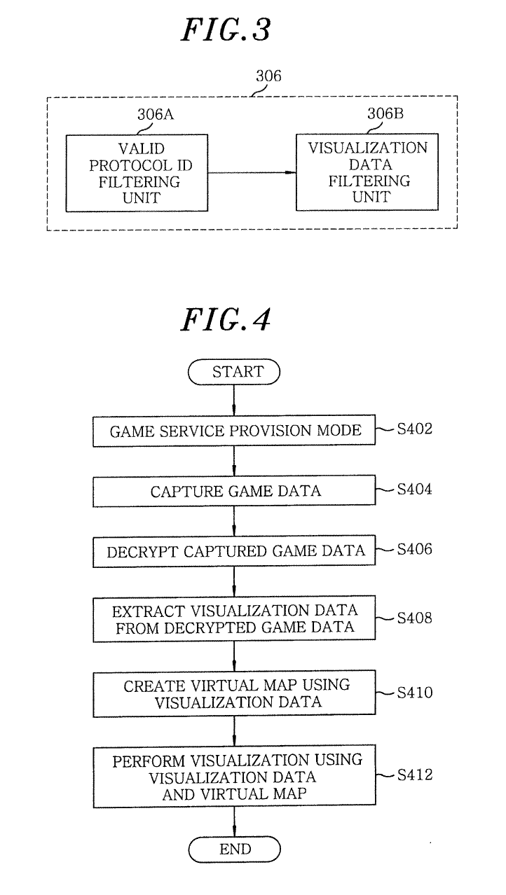

Thereafter, the packet filtering unit 306 extracts a game packet having a valid protocol ID from a continuous protocol list regarding game packet data, extracts game visualization-related data from the game packet having a valid protocol ID, creates fourth game packet data by extracting only packet data including a protocol ID necessary for visualization from the third game packet data decrypted by the decryption unit 304, and creates fifth game packet data, visualization data, by extracting the location and attribute information of an object (e.g., an object name, a HP/MP gauge, a location value, etc.) from the fourth game packet data. The packet filtering unit 306, as shown in FIG. 3, may include a valid protocol ID filtering unit 306A for extracting a game packet having a valid protocol ID from a continuous list regarding game packet data and a visualization data filtering unit 306B for extracting game visualization-related data (e.g., location information, attribute information and the like) from the game packet having a valid protocol ID.

Furthermore, the virtual map creation unit 308 creates a virtual map by extracting location information from the fifth game packet data, i.e., visualization data created by the packet filtering unit 306.

Thereafter, the visualization unit 310 performs visualization and display in the form of a 3D screen or a 2D screen using visualization data and virtual map data.

Accordingly, by capturing game packet data between the game service server and the game client terminal, extracting visualization data by performing decryption and filtering, and creating a virtual map using the location information of the extracted visualization data, and displaying the visualization data in the created virtual map in the form of a 3D or 2D screen, the visualization data can be extracted from the game packet data and can be displayed effectively.

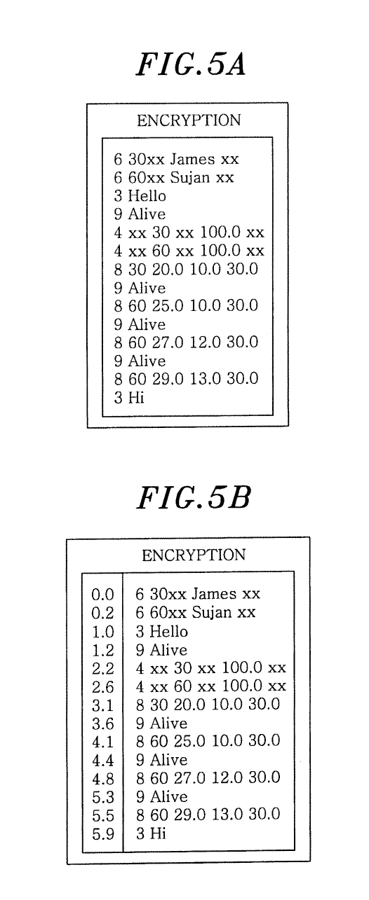

FIG. 4 is a flow chart showing a process of capturing game packets, extracting visualization-related data and visualizing the data according to another embodiment of the present invention.

Referring to FIG. 4, in the game service provision mode of the system for visualizing game data in step 402, the packet capturing unit 302 of the game packet data visualization apparatus 300 captures game packet data, i.e., first game packet data exchanged between the game service server 100 and the game client terminal 200 in step S404. Here, second game packet data is created by adding corresponding time information to the captured first game packet data.

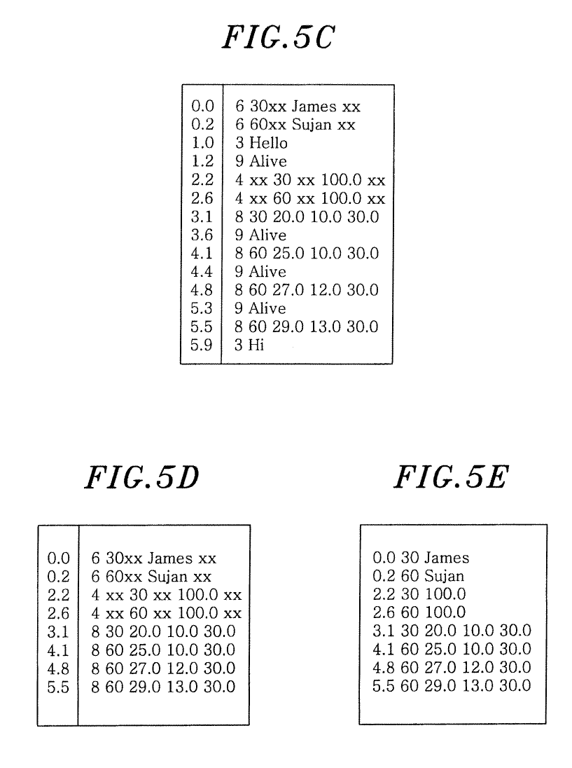

As an example, FIGS. 5A to 5E are diagrams illustrating the extraction and visualization of visualization-related data in accordance with an embodiment of the present invention. Game packet data, such as that shown in FIG. 5A, may be transmitted between the game service server 100 and the game client terminal 200. The game packet data includes No. 6 protocol including a gamer's name information, No. 3 protocol including chatting message information, No. 4 protocol including the HP gauge information of a game object, No. 9 protocol, that is, an alive protocol which is periodically transmitted to check whether a game client application is operating as desired, and No. 8 protocol including the location information of a game object. Second game packet data, such as that shown in FIG. 5b, can be created by adding corresponding time information.

Further, the decryption unit 304 creates third game packet data by decrypting the second game packet data created by the packet capturing unit 302 in step S406. Such decryption may be performed using a decryption algorithm which is provided in script form, such as Lua script form, or in plug-in form. If captured game packet data has not been encrypted, decryption does not need to be performed. Through this process, second game packet data, such as that shown in FIG. 5B, is decrypted, thereby creating third game packet data, such as that shown in FIG. 5C.

Thereafter, the packet filtering unit 306 creates fourth game packet data by extracting only packet data including a protocol ID necessary for visualization from the third game packet data decrypted by the decryption unit 304, and creates fifth game packet data, i.e., visualization data by extracting, e.g., an object name, a HP/MP gauge and a location value from the fourth game packet data in step S408.

As an example, fourth game packet data, such as that shown in FIG. 5D, is created by extracting only packet data having a valid protocol ID from the third game packet data, such as that shown in FIG. 5C. The fourth game packet data, such as that shown in FIG. 5D, is visualization data including the name of an object, an HP/MP gauge and a location value, and is used to create fifth game packet data, such as that shown in FIG. 5E.

The fifth game packet data may be represented as shown in FIG. 5E. ‘0.0 30 James’ is packet data which entered at the time of 0.0 seconds, and represents that the name of game object ID 30 is James. “2.2 30 100.0” is packet data which entered at the time of 2.2 seconds, and represents that the HP gauge value of game object ID 30 is 100.0. “3.1 30 20.0 10.0 30.0” is packet data which entered at the time of 3.1 seconds, and represents that the location information of game object ID 30 is 20.0 10.0 30.0.

Furthermore, the virtual map creation unit 308 extracts location information from the fifth game packet data, i.e., visualization data and creates a virtual map in step S410.

Thereafter, the visualization unit 310 performs visualization and display using visualization data and virtual map data in the form of a 3D or 2D screen in step S412.

Accordingly, by capturing game packet data between the game service server and the game client terminal, extracting visualization data by performing decryption and filtering, and creating a virtual map using the location information of the extracted visualization data, and displaying the visualization data in the created virtual map in the form of a 3D or 2D screen, the visualization data can be extracted from the game packet data and can be displayed effectively.

While the invention has been shown and described with respect to the embodiments, it will be understood by those skilled in the art that various changes and modifications may be made without departing from the spirit of the invention as defined in the following claims.

What is claimed is:

1. An apparatus for visualizing game packet data, comprising:
a packet capturing unit for capturing game packet data transmitted and received during a game service;
a decryption unit for decrypting the captured game packet data;
a packet filtering unit for extracting packet data having a valid protocol ID from the game packet data and extracting visualization data from the extracted packet data;
a virtual map creation unit for creating a virtual map using the extracted visualization data; and
a visualization unit for displaying the visualization data in the created virtual map.

2. The apparatus of claim 1, wherein the packet capturing unit captures the game packet data and adds corresponding time information to the game packet data.

3. The apparatus of claim 1, wherein the decryption unit performs the decryption using a decryption algorithm which is provided in script or plug-in form.

4. The apparatus of claim 3, wherein the script form in which the decryption algorithm is provided is Lua script form.

5. The apparatus of claim 1, wherein the packet filtering unit comprises:
a valid protocol ID filtering unit for extracting a game packet having the valid protocol ID from a continuous protocol list regarding the decrypted game packet data; and
a visualization data filtering unit for extracting the visualization data from the game packet having the valid protocol ID.

6. The apparatus of claim 5, wherein the visualization data comprises location and attribute information of an object.

7. The apparatus of claim 1, wherein the virtual map creation unit creates the virtual map using location information of the visualization data.

8. The apparatus of claim 7, wherein the visualization unit displays the visualization data in 3D or 2D screen form.

9. A method for visualizing game packet data, comprising:
capturing game packet data transmitted and received during a game service;
decrypting the captured game packet data;
extracting packet data having a valid protocol ID from the game packet data;
extracting visualization data from the extracted packet data;
creating a virtual map using the extracted visualization data; and
displaying the visualization data in the created virtual map.

10. The method of claim 9, wherein the packet capturing unit captures the game packet data and adds corresponding time information to the game packet data.

11. The method of claim 9, wherein the decrypting the captured game packet data is performed using a decryption algorithm which is provided in script or plug-in form.

12. The method of claim 11, wherein the script form in which the decryption algorithm is provided is Lua script form.

13. The method of claim 9, wherein the extracting packet data comprises extracting a game packet having the valid protocol ID from a continuous protocol list regarding the decrypted game packet data.

14. The method of claim 13, wherein the visualization data comprises location and attribute information of an object.

15. The method of claim 9, wherein the creating a virtual map is performed using location information of the visualization data.

16. The method of claim 15, wherein the displaying the visualization data comprises displaying the visualization data in 3D or 2D screen form.
